(19) United States
(12) Patent Application Publication
(10) Pub. No.: US 2015/0042821 A1
(43) Pub. Date: Feb. 12, 2015

(54) HANDHELD DEVICE AND METHOD FOR CONTROLLING ORIENTATION OF DISPLAY OF HANDHELD DEVICE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: JIAN-HUNG HUNG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/972,905

(22) Filed: Aug. 22, 2013

(30) Foreign Application Priority Data
Aug. 6, 2013 (CN) 2013103383010

(51) Int. Cl. H04N 5/232

(52) U.S. Cl. CPC H04N 5/23293; H04N 5/23222
USPC 348/207.1

(57) ABSTRACT

In a method for controlling display orientation of a handheld device, a gravity sensor detects an instantaneous rotation of the handheld device. A front-facing camera of the handheld device captures an image of a user of the handheld device and a determination is made as to whether the user is in a vertical orientation or in a horizontal orientation by analyzing the captured image. If the user is parallel with the handheld device as being in the horizontal orientation, a horizontal display function of the handheld device is disabled, but if the user is perpendicular to the handheld device as being in the horizontal orientation, the horizontal display function of the handheld device is enabled.

### BACKGROUND

1. Technical Field

The embodiments of the present disclosure relate to a handheld device and method for controlling an orientation of a display of the handheld device.

2. Description of Related Art

Some handheld devices, such as smart phones, have a displaying function that can switch displays of the handheld devices' orientation from a vertical orientation to a horizontal orientation when the handheld devices are rotated from the vertical orientation to the horizontal orientation. However, there is a problem when, for example, a user of a handheld device is lying in a horizontal orientation as shown in FIG. 6, where the handheld device still rotates a display of the handheld device from the vertical orientation to the horizontal orientation. This change of orientation is inconvenient and undesirable to the user.

### BRIEF DESCRIPTION OF THE DRAWINGS

FIG. 1 is a block diagram of one embodiment of a handheld device including a display control system.

FIG. 2 is a block diagram of one embodiment of function modules of the display control system in FIG. 1.

FIG. 3 is a flowchart of one embodiment of a method for controlling an orientation of a display of the handheld device.

FIG. 4 and FIG. 5 show different states of applying the method for controlling the orientation of the display of the handheld device.

FIG. 6 shows the method for controlling the orientation of the display of the handheld device of related art being applied.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

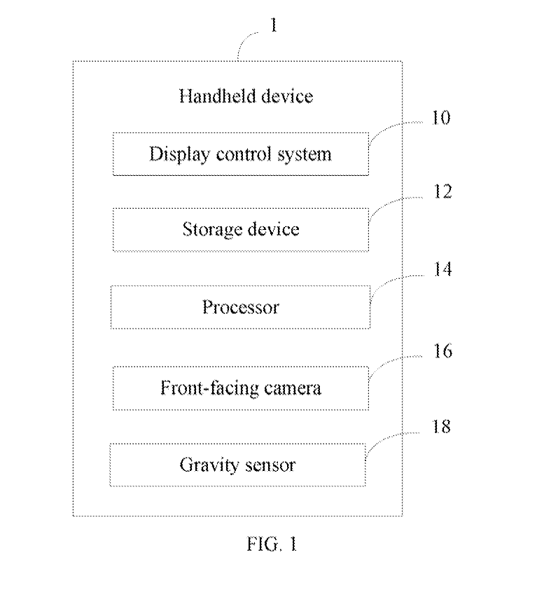

FIG. 1 is a block diagram of one embodiment of a handheld device 1 including a display control system 10, a storage device 12, at least one processor 14, a front-facing camera 16, and a gravity sensor 18. The handheld device 1 may be a cellular phone, a master production scheduler (MPS), a personal digital assistant (PDA), or other mobile electronic device.

In one embodiment, the storage device 12 (a non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

The front-facing camera 16 captures an image of a user in front of the handheld device 1 when the gravity sensor 18 detects an instantaneous rotation of the handheld device 1. In the embodiment, the rotation of the handheld device 1 indicates that the handheld device 1 is rotated from a vertical orientation to a horizontal orientation, or vice versa.

In one embodiment, the display control system 10 includes a plurality of function modules which include computerized codes or instructions that can be stored in the storage device 12 and executed by the at least one processor 14 to provide a method for controlling the orientation of the display of the handheld device 1.

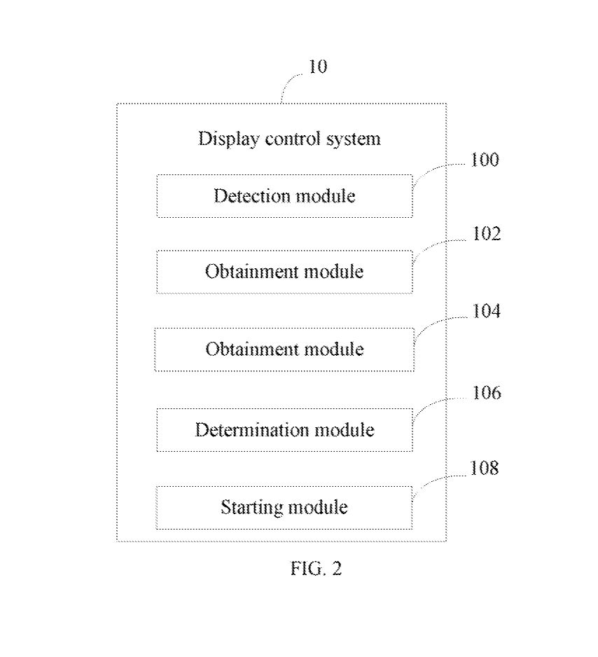

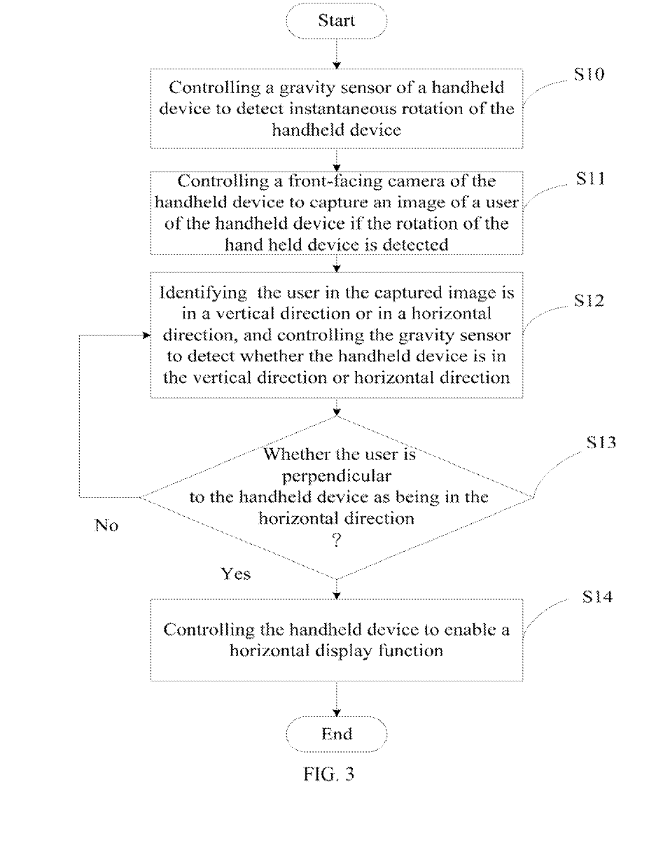

FIG. 2 is a block diagram of one embodiment of function modules of the display control system 10 in FIG. 1. In the embodiment, the display control system 10 includes a detection module 100, an obtainment module 102, an identifying module 104, a determination module 106, and starting module 108. The modules may comprise computerized codes in the form of one or more programs that are stored in the storage device 12 and executed by the at least one processor 14 to provide functions for implementing the display control system 10. The functions of the function modules are illustrated in FIG. 3 and described below.

FIG. 3 is a flowchart illustrating one embodiment of a method for controlling the orientation of the display of the handheld device 1. Depending on the embodiment, additional steps may be added, others removed, and the ordering of the steps may be changed.

In step S10, the detection module 100 detects an instantaneous rotation of the hand held device 1 using the gravity sensor 18.

In step S11, the obtainment module 102 controls the front-facing camera 16 of the handheld device 1 to capture an image of the user in front of the handheld device 1 if the instantaneous rotation of the hand held device 1 is detected by the gravity sensor 18.

In step S12, the identifying module 104 identifies the user in the captured image as being in the vertical orientation or the horizontal orientation, and obtains data from the gravity sensor 18 to identify whether the handheld device is itself held vertically or horizontally.

In step S13, the determination module 106 also determines whether the user is perpendicular to the handheld device 1 according to the identified user in the captured image if the handheld device 1 is in the horizontal orientation. In the embodiment, if the user is in the vertical orientation and the handheld device 1 is in the horizontal orientation, the user is perpendicular to the handheld device 1. In the embodiment, the orientation of the user may be obtained by identifying the captured image using Open CV software as a tool.

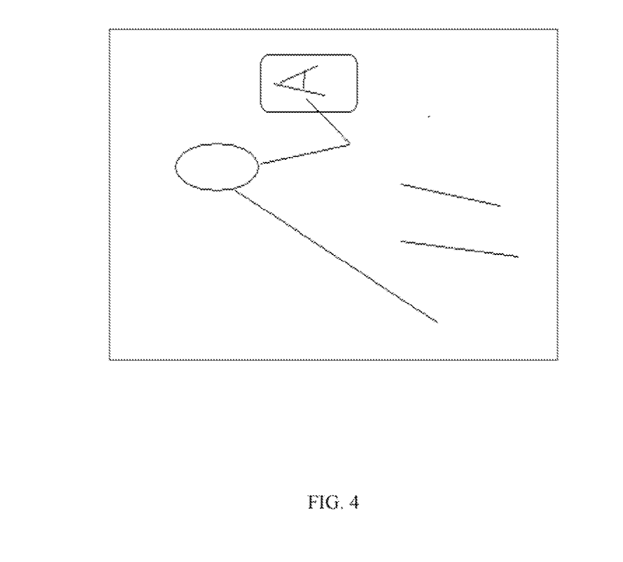

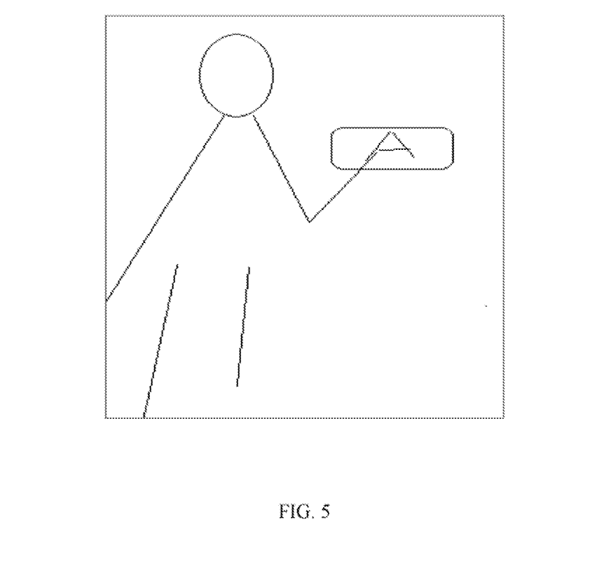

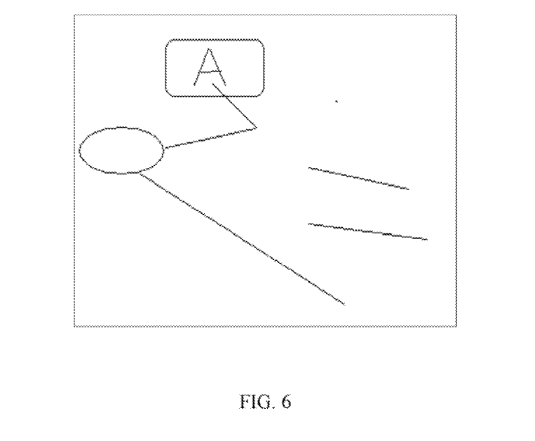

In step S14, the starting module 108 controls the handheld device 1 to enable a horizontal display function if the user is perpendicular to the handheld device 1. If the user is parallel with the handheld device 1, the horizontal display function is disabled. In the embodiment, the horizontal display function may switch the orientation of the display of the handheld device 1 from the vertical orientation to the horizontal orientation when the handheld device 1 is rotated from the vertical orientation to the horizontal orientation, and switches the orientation of the display of the handheld device 1 back to the vertical orientation when the handheld device 1 is rotated back to the vertical orientation. As shown in FIG. 5, the gravity sensor 18 detects that the handheld device 1 is rotated from the vertical orientation to the horizontal orientation, and the user is perpendicular to the handheld device 1. The horizontal display function is enabled to, for example, switch the display of a letter “A” from the vertical orientation to the horizontal orientation. However, as shown in FIG. 4, if the handheld device 1 is in the horizontal orientation, the horizontal display function is disabled because the user is already parallel to the handheld device 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A handheld device, comprising:
a storage device storing a computer program including instructions that, which executed by the at least one processor, causes the at least one processor to:
control a gravity sensor of the handheld device to detect an instantaneous rotation of the handheld device;
control a front-facing camera of the handheld device to capture an image of a user in front of the handheld device if the instantaneous rotation of the hand held device is detected;
determine whether the user is in a vertical orientation or in a horizontal orientation, and control the gravity sensor to detect whether the handheld device is in the vertical orientation or the horizontal orientation;
determine whether the user is perpendicular to the handheld device as being in the horizontal orientation; and
control the handheld device to enable a horizontal display function if the user is perpendicular to the handheld device.

2. The handheld device as claimed in claim 1, wherein the user is perpendicular to the handheld device if the user is in the vertical orientation and the handheld device is in the horizontal orientation.

3. The handheld device as claimed in claim 1, wherein the horizontal display function switches the display orientation of the handheld device from the vertical orientation to the horizontal orientation when the handheld device rotated from the vertical orientation to the horizontal orientation, and switches the display orientation of the handheld device back to the vertical orientation when the handheld device rotated back to the vertical orientation.

4. A method executable by a processor of an handheld device for controlling an orientation of a display of the handheld device, comprising:
controlling a gravity sensor of a handheld device to detect instantaneous rotation of the handheld device;
controlling a front-facing camera of the handheld device to capture an image of a user in front of the handheld device if the rotation of the hand held device is detected;
analyzing the captured image of the user to identify that the user as being in vertical orientation or in horizontal orientation, and controlling the gravity sensor to detect whether the handheld device is in the vertical orientation or in horizontal orientation;
determining whether the user is perpendicular to the handheld device as being in the horizontal orientation; and
controlling the handheld device to enable a horizontal display function if the user is perpendicular to the handheld device.

5. The method as claimed in claim 4, wherein the user is perpendicular to the handheld device if the user is in the vertical orientation and the handheld device is in the horizontal orientation.

6. The method as claimed in claim 4, wherein the horizontal display function switches the display orientation of the handheld device from the vertical orientation to the horizontal orientation when the handheld device is rotated from the vertical orientation to the horizontal orientation, and switches the display orientation of the handheld device back to the vertical orientation when the handheld device rotated back to the vertical orientation.

7. A non-transitory computer-readable storage medium having stored thereon instructions being executed by a processor of a handheld device, causes the processor to perform a method for controlling an orientation of a display of the handheld device, the method comprising:
controlling a gravity sensor of the handheld device to detect instantaneous rotation of the handheld device;
controlling a front-facing camera of the handheld device to capture an image of a user in front of the handheld device if the rotation of the hand held device is detected;
analyzing the captured image of the user to identify that the user as being in vertical orientation or in horizontal orientation, and controlling the gravity sensor to detect whether the handheld device is in the vertical orientation or in horizontal orientation; and
determining whether the user is perpendicular to the handheld device as being in the horizontal orientation; and
controlling the handheld device to enable a horizontal display function if the user is perpendicular to the handheld device.

8. The storage medium according to claim 7, wherein the user is perpendicular to the handheld device if the user is in the vertical orientation and the handheld device is in the horizontal orientation.

9. The storage medium according to claim 7, wherein the horizontal display function switches the orientation of the display of the handheld device from the vertical orientation to the horizontal orientation when the handheld device rotated from the vertical orientation to the horizontal orientation, and switches the orientation of the display of the handheld device back to the vertical orientation when the handheld device rotated back to the vertical orientation.
